(19) United States
(12) Patent Application Publication
(10) Pub. No.: US 2026/0180644 A1
(43) Pub. Date: Jun. 25, 2026

(54) METHODS OF CSI REPORTING FOR RATE SPLIT DOWNLINK TRANSMISSION

(71) Applicant: InterDigital Patent Holdings, Inc., Wilmington, DE (US)

(72) Inventors: Omid Saatlou, Montreal (CA); Afshin Haghighat, Ile-Bizard (CA); Mohammad Irfan, Chateauguay (CA); Loic Canonne-Velasquez, Dorval (CA); Moon IL Lee, Melville, NY (US)

(73) Assignee: InterDigital Patent Holdings, Inc., Wilmington, DE (US)

(21) Appl. No.: 18/987,681

(22) Filed: Dec. 19, 2024

(51) Int. Cl. H04B 7/06; H04B 7/0456; H04W 24/10

(52) U.S. Cl. CPC H04B 7/0626; H04B 7/0456; H04W 24/10

(57) ABSTRACT

A wireless transmit/receive unit (WTRU) may receive configuration information. The configuration information may include a first channel state information (CSI) configuration information and/or a second CSI configuration. The first CSI configuration information may be associated with reception of common message of rate splitting-based (RS-based) transmission. The second CSI configuration may be associated with reception of WTRU-specific messages of RS-based transmission. The WTRU may determine at least a first CSI feedback based on, for example, the first CSI configuration associated with the common messages of RS-based transmission. The WTRU may determine at least a second CSI feedback based on, for example, the second CSI configuration associated with the WTRU-specific messages of RS-based transmission. The WTRU may transmit at least one CSI report. The at least one CSI report may include the at least first CSI feedback and/or the at least one second CSI feedback.

### BACKGROUND

Multi-user multi-antenna (e.g., conventional) approaches such as spatial division multiple access (SDMA)/multiuser multiple input multiple output (MU-MIMO) may be based on timely and/or (e.g., highly) accurate channel state information (CSI) at transmitter (CSIT).

### SUMMARY

A wireless transmit/receive unit (WTRU) may receive configuration information. The configuration information may include a first channel state information (CSI) configuration information and/or a second CSI configuration. The first CSI configuration information may be associated with reception of common message of rate splitting-based (RS-based) transmission. The second CSI configuration may be associated with reception of WTRU-specific messages of RS-based transmission. The WTRU may determine at least a first CSI feedback based on, for example, the first CSI configuration associated with the common messages of RS-based transmission. The WTRU may determine at least a second CSI feedback based on, for example, the second CSI configuration associated with the WTRU-specific messages of RS-based transmission. The WTRU may transmit at least one CSI report. The at least one CSI report may include the at least first CSI feedback and/or the at least one second CSI feedback.

The at least one CSI report may include a first CSI report and/or a second CSI report. The first CSI report may include the at least first CSI feedback. The second CSI report may include the at least second CSI feedback.

The first CSI configuration may include first CSI report configuration information associated with the first CSI report. The second CSI configuration may include second CSI report configuration information associated with the second CSI report. Transmitting the at least one CSI report may include transmitting the first CSI report based on the first CSI report configuration information. Transmitting the at least one CSI report may include transmitting the second CSI report based on the second CSI report configuration information.

The WTRU being configured to transmit the first CSI feedback may include the WTRU being configured to transmit an indication that indicates a first subset of spatial-domain basis vectors and/or beam combining coefficients associated with the common messages of RS-based transmission. The WTRU being configured to transmit the second CSI feedback may include the WTRU being configured to transmit an indication that indicates a second subset of spatial-domain basis vectors and/or beam coefficients associated with the WTRU-specific messages of RS-based transmission.

The first CSI report may be associated with a first precoding matrix indicator (PMI) codebook. The second CSI report may be associated with a second PMI codebook. The WTRU being configured to transmit the first CSI report may include the WTRU being configured to transmit an indication that indicates the first PMI codebook from a first codebook. The WTRU being configured to transmit the second CSI report may include the WTRU being configured to transmit the second PMI codebook from a second codebook.

The WTRU being configured to determine the first CSI feedback may include the WTRU being configured to determine a rank indicator (RI), channel quality indicator (CQ), and/or PMI associated with the common messages of RS-based transmission. The WTRU being configured to determine the second CSI feedback may include the WTRU being configured to determine a RI, CQ, and/or PMI associated with the WTRU-specific messages of RS-based transmission.

The at least one CSI report may include at least one CSI phase factor between a common messages PMI associated with the common messages of RS-based transmission and a WTRU-specific PMI associated with the WTRU-specific messages of RS-based transmission. The at least one CSI phase factor may be indicative of the orthogonality between the common messages PMI and the WTRU-specific PMI.

The WTRU being configured to transmit the first CSI feedback may include the WTRU being configured to transmit an indication indicating the common messages PMI. The WTRU being configured to transmit the second CSI feedback may include the WTRU being configured to transmit an indication indicating the WTRU-specific PMI. The WTRU being configured to transmit the at least one CSI report may include the WTRU being configured to transmit an indication indicating the at least one phase factor.

The configuration information may include a first RS configuration and/or a second RS configuration. The first RS configuration may be associated with the common messages of RS-based transmission. The second RS configuration may be associated with the WTRU-specific messages of RS-based transmission.

A base station may send configuration information. The configuration information may include a first CSI configuration and/or a second CSI configuration. The first CSI configuration may be associated with reception of common messages of rate splitting-based (RS-based) transmission. The second CSI configuration may be associated with reception of WTRU-specific messages of RS-based transmission. The base station may receive at least one CSI report. The at least one CSI report may include at least first CSI feedback and/or at least second CSI feedback. The at least one CSI feedback may be determined based on the first CSI configuration associated with the common messages of RS-based transmission. The at least second CSI feedback may be determined based on the first CSI configuration associated with the WTRU-specific messages of RS-based transmission.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example rate-splitting (RS) with a common portion and/or a private portion.

FIG. 3 depicts an example RS architecture at the receiver side.

FIG. 4 depicts an example of RS layers at transmitter.

FIG. 5 depicts an example of RS and non-RS layers at transmitter.

FIG. 6 depicts an example of RS with a common portion and a private portion for two users.

FIG. 7 depicts an example of RS with a common portion and a private portion for two users and a message combiner.

FIG. 8 depicts an example of RS architecture at the receiver side for wireless transmit/receive unit (WTRU) 1 and WTRU 2.

### DETAILED DESCRIPTION

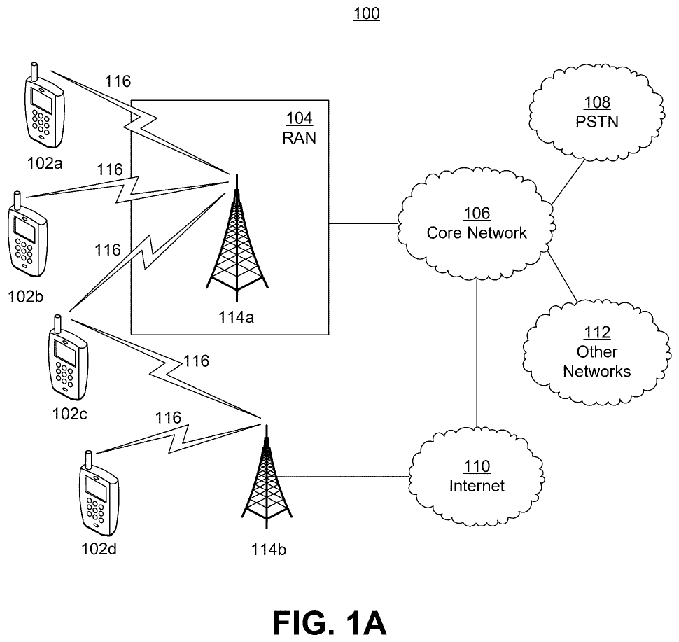

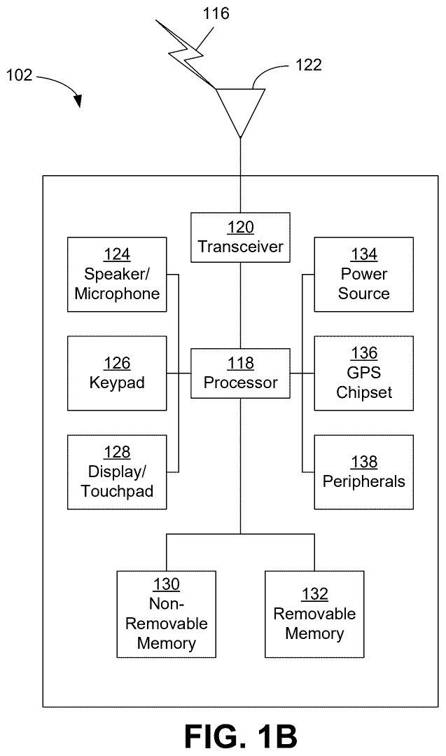

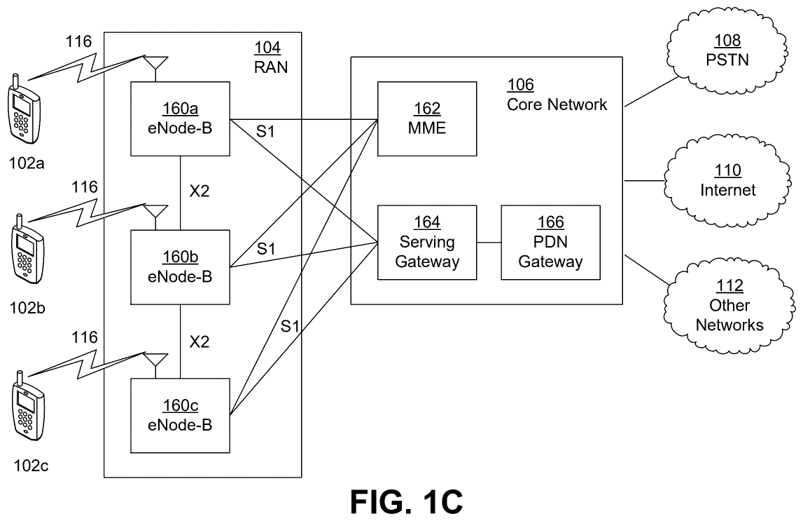

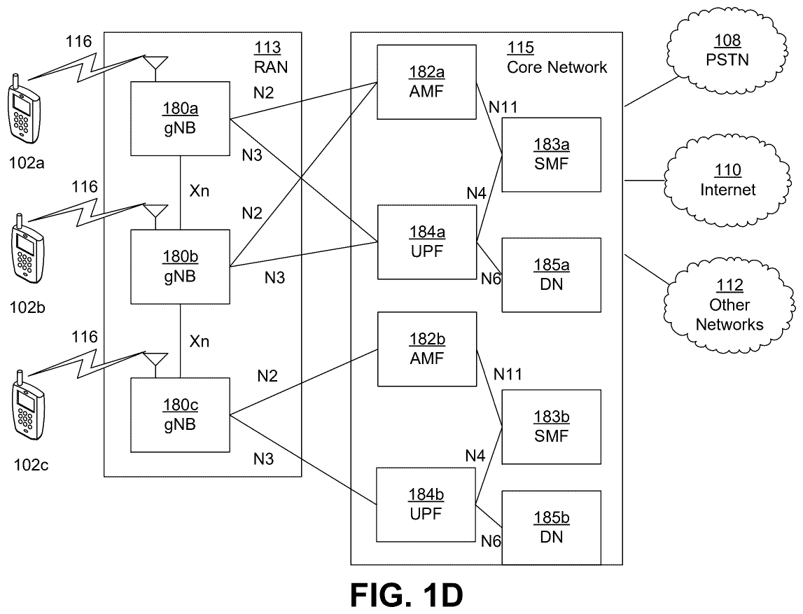

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication.

Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams.

Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11 ah. The channel operating bandwidths, and carriers, are reduced in 802.11af and 802.11 ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment.

The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Multiuser multiple input multiple output (MU-MIMO) may be a promising technology to support a large number of users with high data rate including delivery of broadcast/multicast (e.g. popular live events) and unicast (e.g. user personalized). There may be one or more (e.g., some) feature proposals to study on advanced MIMO techniques to enhance spectral efficiency (SE) of unicast (e.g., only) delivery, and/or joint unicast/multicast delivery. One of these proposals may be rate splitting (RS) for MU-MIMO.

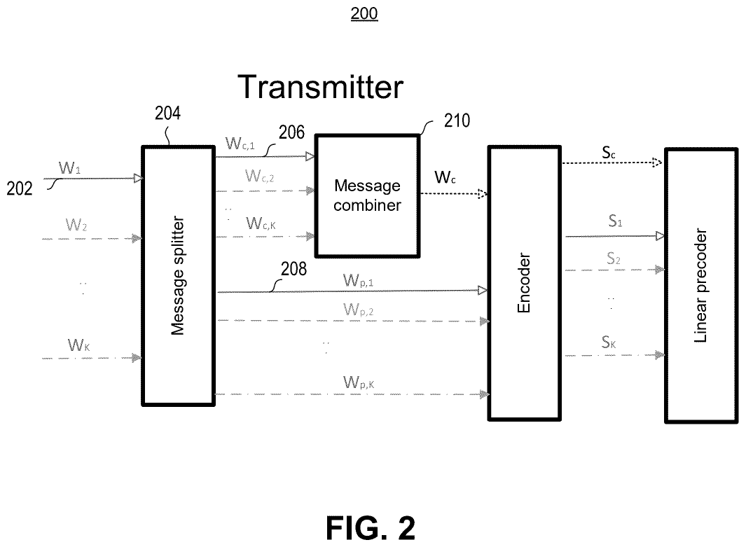

A rate splitting-based (RS-based) transmission can be implemented in one or more (e.g., several) different ways. The transmitter may split the message into a common part and a private (e.g., dedicated, WTRU-specific) part as shown in FIG. 2, where Wᵢ is the data stream of i^{th} user splitting into the common part, e.g., W_{c,i} and/or the private part, e.g., W_{p,i}. The terms part and portion may be used interchangeably herein. The terms private, WTRU-specific, and/or dedicated may be used interchangeably herein. A common message based on combining one or more (e.g., all) W_{c,i}'s may be produced and/or coded prior to transmission. Concurrently, each W_{p,i} may be independently coded and/or transmitted. This may mean that one or more (e.g., all) users receive the common part in a common stream and/or the private part in a private stream that are superposed in a non-orthogonal manner. The common stream may be decodable by one or more (e.g., all) users; the private stream may be (e.g., only) decodable by the intended user.

FIG. 2 depicts an example of rate splitting (RS) with a common part and a private part 200. For example, message splitter 204 may split W1 202 to W_{c,1} 206 and/or W_{p,1} 208. W_{c,1} 206 may (e.g., only) go to the message combiner 210. The message combiner 210 may be designed at the gNB. The gNB may be aware of W_{c,1} 206 and/or may sent it to message combiner 210.

In Type-I and/or Type-II channel state information (CSI), a wireless transmit/receive unit (WTRU) may select a precoding matrix index (PMI) from a pre-defined codebook, where the number of available beams in the codebook may be a function of the number of CSI-RS ports and/or the Discrete Fourier Transform (DFT)-oversampling. Particularly, the total number of beams in the codebook may be given by N₁N₂O₁O₂, where N₁ and/or N₂ may be the number of antenna ports per polarization in a horizontal and/or vertical dimension, and where O₁ and O₂ may be the DFT beam oversampling factors in a horizontal and/or vertical dimension, respectively. The PMI structure of (e.g., both) Type-I and/or Type-II in matrix form can be expressed as W=W₁W₂, where W₁ may capture the wideband information of the channel and/or where W₂ may capture detailed sub-band information of the channel.

Additionally or alternatively, NR may supports an upgraded variant of Type-I CSI, known as the Type-II CSI to better characterize a multi-path channel. One (e.g., major) difference between Type-I and Type-II CSI may include the number of selected beams in W₁. Type-I may support a single beam operation whereas Type-II may support one or more (e.g., multiple) beams operation, where each DFT-beam may have its corresponding beam-combining co-efficient and/or which corresponds to amplitude scaling and/or angular information of a path. Type-II may provide a higher resolution CSI which enables the network to generate more accurate precoders. Type-II may (e.g., also) be more beneficial for MU-MIMO user pairing since it provides better spatial separation between users, which may reduce inter-user interference. Type-II CSI may outperform Type-I, but at the expense of an increased feedback overhead due to the WTRU reporting a linear combination of one or more (e.g., multiple) beams which includes quantized beam-combining coefficients.

The structure of Type-II codebook may be similar to Type-I, e.g., W=W₁W₂, where unlike Type-I CSI, one or more (e.g., multiple) beams may be included in W₁ of a Type-II PMI. The beam-combining coefficients may be captured in W₂. An enhanced variant of Type-II CSI may have been introduced (e.g., in Rel. 16) to prevent excessive growth of the uplink control information (UCI) payload size through a frequency domain (FD) compression of the beam-combining coefficients. The feedback overhead of Type-II codebooks may remain significant and/or may approximately linearly increase with the number of sub-bands. In Enhanced Type-II, the supported number of beams may have increased from 4 to 6, and/or the supported number of layers may have increased from 2 to 4. Additionally or alternatively, the support for Type-II CSI may have extended (e.g., in Rel. 18) to a high Doppler and/or coherent joint transmission (CJT) use-cases.

With more than two antenna ports, Type-I CSI may support one or more (e.g., two) modes of operation (e.g., Mode 1, Mode 2) included in the RRC parameter codebookMode. With respect to Type-I Mode 1: the WTRU may measure a CSI resource and/or may determine a single DFT-beam from the pre-defined codebook as a wideband PMI. Additionally or alternatively, the WTRU may determine a co-phasing value to co-phase the cross-polarization antenna ports. The overhead of reporting the wideband PMI and/or W₁ may be [log₂(N₁O₁)] and/or [log₂(N₂O₂)] bits to identify the beam index in the respective horizontal and/or vertical dimensions, whereas the overhead of reporting the co-phasing can be up to two bits per sub-band. With respect to Type-I Mode 2, the codebook may be divided into one or more (e.g., multiple) beam groups, where each beam group may include four beams. The WTRU may measure a CSI resource and/or may report a beam group as a wideband PMI and/or W₁. In each sub-band, the WTRU may determine one out of the available four beams in W₁ and/or may report it to the gNB. The overhead of PMI reporting in Mode 2 may be [log₂(N₁O₁/2)] and/or [log₂(N₂O₂/2)] bits to identify the beam index per dimension of the first beam in the beam group and/or four bits per sub-band for selecting one out of the available four beams with a co-phasing factor. Compared to Mode 1, for example, the PMI in Mode 2 may be optimized at a sub-band level and/or may result in a better performance at the expense of an increased feedback overhead.

Multi-user multi-antenna (e.g., conventional) approaches such as spatial division multiple access (SDMA)/MU-MIMO may (e.g., heavily) be based on timely and/or (e.g., highly) accurate CSI at transmitter (CSIT). CSIT may (e.g., always) be imperfect due to pilot reuse, channel estimation errors, pilot contamination, limited and/or quantized feedback accuracy, delay/latency, mobility (e.g., due to ever-increasing speeds of vehicle/trains/satellite/flying objects and/or emerging applications as Vehicle-to-Everything), radio frequency (RF) impairments (e.g., phase noise), inaccurate calibrations of RF chains, sub-band level estimation, and/or the like. Consequently, SDMA/MU-MIMO may be (e.g., inherently) non-robust.

Rate splitting multiple access (RSMA) can be employed to design a robust MIMO wireless networks that may account for imperfect CSIT and/or its corresponding interference. In an RSMA-based system, one or more (e.g., all) users may receive the common part in a common stream and/or the private part in a private stream that are superposed in a non-orthogonal manner. At the receiver side, each WTRU may (e.g., first) decode the common data streams of one or more (e.g., all) users using successive interference cancellation (SIC). Each WTRU may (e.g., then) decode its own private data stream by treating the interference as a noise. The terms private data stream, private message, and/or private data message(s) may be used interchangeably herein. The terms common data stream, common message, and/or common data messages may be used interchangeably herein.

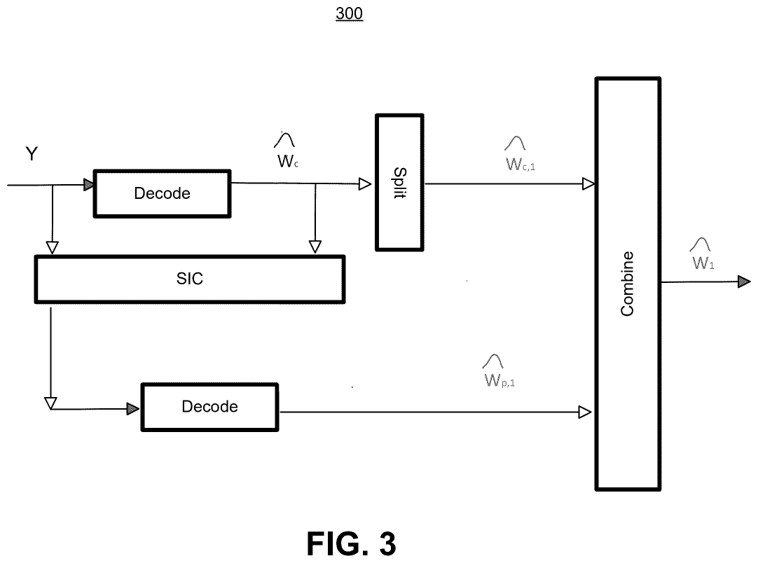

FIG. 3 shows the receiver architecture for RS for (e.g., only) user 1 and/or the other WTRUs follow the same architecture 300. A WTRU may (e.g., first) decode the common data stream and/or may extract the common data stream related to the WTRU. Using the successive interference cancelation (SIC), the WTRU may (e.g., then) decode the intended private data stream. The WTRU may combine the common and private data streams to obtain the whole data stream.

RS approach may be employed for a downlink transmission, where the data stream of each WTRU may be split to common and/or private portions. The common part of each WTRU can be combined in gNB and/or sent as a combined message. Another (e.g., new) mechanism may be proposed in such a way that the WTRU estimates and/or reports the CSIs associated to each portion. Embodiments described herein may include different schemes for reporting CSI.

Reporting an accurate CSI for (e.g., both) common and/or private portions may play an (e.g., important) role to design such a scheme. Embodiments described herein may address different aspects related to CSI operation for RS-based downlink transmission, including CSI configuration for common and/or private data messages, CSI reporting for common and/or private data messages, and/or codebooks for common and/or private data messages.

Embodiments described herein for broadcast/multicast and unicast can be viewed as splitting the messages of each UE to two portions, including the common and/or private portions. This scheme can support high throughput by mitigating the interference. Reporting an accurate CSI for (e.g., both) common and/or private portions may play an important role to design such a scheme.

Embodiments described herein may include methods of CSI reporting for RS-based downlink transmission.

A WTRU may receive CSI configuration associated with common and/or private messages. A WTRU may receive CSI configuration including one or more of the following. The WTRU may receive an initial power offset (ac) between the allocated power for common and private messages, where WTRU may apply the power offset for CSI estimation for each of the messages, e.g., estimation of channel quality indicator (CQI), PMI for the private (common) message, etc. For example, the WTRU may report separate CQ estimates for the common and private data streams, where the WTRU may send one or more CQ for the private and a delta value, e.g., Δ(α_{c}) to represent the common portion. The WTRU may receive configuration information. The configuration information may include a first CSI configuration and a second CSI configuration. The first CSI configuration may be associated with reception of common messages of rate-splitting (RS-based) transmission. The second CSI configuration may be associated with reception of WTRU-specific messages of RS-based transmission. The configuration information may include a power offset between the common messages of RS-based transmission and the WTRU-specific messages of RS-based transmission.

The WTRU may receive a first and/or a second CSI configuration for the common and/or the private messages, respectively. The first and/or the second CSI configuration may include, respectively, a first and/or second configuration for report quantity, and/or a first and second configuration for CSI resources, etc. For example, the WTRU may report CSI quantity rank indicator (RI)-CQI for the common message, and/or RI-PMI-CQI for the private message, etc. In examples, the WTRU may report CSI for the common message aperiodically, while the WTRU may report CSI for the private message periodically. Additionally or alternatively, the WTRU may report CSI for the common message periodically, while the WTRU may report CSI for the private message aperiodically.

The WTRU may receive a first and/or second configuration for PMI reporting. A first codebook may be used for PMI determination associated with the common message, and/or a second codebook may be associated with the private message. For example, the WTRU may use a first oversampling ratio for PMI determination associated to the common message, and/or a second oversampling ratio for PMI determination associated to the private messages. A first and/or second PMI feedback resolution may be associated with the common message, and/or a second PMI feedback resolution associated with the private message. For example, the WTRU may report WB PMI for the common message, and/or subband PMI for the private message.

A WTRU may send a report associated with common and/or private messages. For example, a WTRU may report a phase factor to orthogonalize the PMIs between the private and common messages. The phase factor may be indicative of the orthogonality between the common messages PMI and the WTRU-specific PMI. The phase factor may be configured to maintain and/or maximize orthogonality between the common messages PMI and the WTRU-specific PMI.

When a same codebook is used for common and private messages, for example, a WTRU may do one or more of the following. When a same codebook is used for common and private messages, the WTRU may report a first subset of spatial-domain basis vectors and/or beam-combining coefficients for the common message, and/or a second subset of spatial-domain basis vectors and/or beam-combining coefficients for the private message. When a same codebook is used for common and private messages, the WTRU may report a single subset of spatial-domain basis vectors for (e.g., both) common and/or private messages, and/or one or more (e.g., two) subsets of beam-combining coefficients for the common message and private message, respectively.

A WTRU may receive a CSI-reference signal (CSI-RS) resource configuration to measure CSI for the private and/or common portions. In examples, the WTRU may be configured with a single RS resource set (e.g., CSI-RS resource set) and/or the WTRU may use the single RS resource set to determine the CSI contents for the common and/or private portions. Separate CSI reports for common and private portions may be configured and/or associated to each other. Different sub-configuration of the CSI-RS resource and/or resource set may be configured to determine the CSI contents, and/or each of the common and/or private CSI reporting contents may be associated to a different sub-configuration. Each sub-configuration may configure different parameters from the same CSI-RS resource. The different parameters may include one or more of the following: number of ports, power offset, polarization, analog beam (e.g., TCI, CRI or SSBRI). For example, the WTRU may be configured with CSI-RS resource RS1 with N ports, and/or may be configured with CSI report M1 for the common portion, and M2 for the private portion. M1 may be configured with CSI-RS resource RS1 with a port subset indicating the WTRU to measure a CSI over N1<=N ports, and/or M2 may be configured with CSI-RS resource RS1 with a port subset indicating the WTRU to measure a CSI over N2<=N ports. Additionally or alternatively, M1 and/or M2 may be configured with power offsets P1 and P2 respectively to determine the CSI from RS1.

If one or more (e.g., multiple) CSI-RS are configured, for example, each CSI-RS may be associated with an index (CRI) and/or one or more quasi co-located (QCL) determinations (e.g., given by a transmission control indicator (TCI) state). The WTRU may be configured to measure and/or report a first CRI for the common portion, and/or a second CRI for the private portion.

The WTRU may include two CRIs in a CSI report to indicate the TCI states used to measure each of the common and/or private portions. The WTRU may be configured with CSI-RS resource pairs and/or may be configured with an association to indicate which CSI-RS resource to use for the common portion and/or private portion CSI determination, where the CSI-RSs may be configured in different CSI-RS resource sets. The association may be between resource set indices, and/or between resource indices within the sets. Within a resource set, two different resource settings may be configured, where each setting may be associated to a subset of the CSI-RS resources in the set. Resource setting may include the number of antenna ports, periodicity (e.g., period length in seconds), power offset(s), and/or resource element density in frequency. For example, the WTRU may be configured with a higher periodicity to measure the CSI-RSs associated with the common portion, and/or a lower periodicity to measure the CSI-RSs associated with the private portion.

A WTRU may be configured for private and/or common RS with a single aperiodic (AP)-CSI-RS triggering command. CSI reporting content (e.g., some CSI reporting content) for one of the portions (e.g., private or common) may be based on the measurement of an RS for the associated part (e.g., common or private, respectively). For example, the WTRU measurement for the private portion may be a function of the WTRU's measurement on the common part. If both RSs are AP triggered, for example, the WTRU may determine a rule to determine the association between a common RS measurement and a private RS measurement since one or more (e.g., multiple) instances may be AP triggered. If the CSI-RS resource configurations for private and common portions are configured with AP triggering, for example, a single aperiodic trigger may be configured to signal to the WTRU to measure CSI on both resources. The WTRU may receive a single AP trigger (e.g., in a downlink control information (DCI)) that is configured with both linked resources, where the link between resources may be radio resource configuration (RRC) configured (and/or medium access control control element (MAC-CE) activated/deactivated). If separate trigger states are configured per private and common portion(s), for example, the WTRU may determine that CSI measurements are linked in time based on the most recently triggered type (private or common) RS configuration. For example, a WTRU may be configured with RS1 for the private portion with a first AP trigger T1, and/or RS2 for the common portion with a second AP trigger T2. When the WTRU is triggered with T1 (private RS1), for example, the WTRU may determine that the associated measurement for the common portion is based on the most recent measurement when T2 was triggered. The WTRU may (e.g., then) determine the CSI content for the private portion based on the measurement on RS1 and/or as a function of the measurement on the associated RS2.

A WTRU may be configured with private and/or common RS configurations in a single CSI report. The WTRU may receive a CSI reporting configuration which is associated to the resource configuration for private and/or common portions. For example, a single CSI report configuration may be configured with (e.g., both) reference signal resource configurations for the private and/or common portions. The AP-CSI triggering command may include an indication to trigger the private RS configuration (e.g., only), to the common RS configuration (e.g., only), and/or to both. When the WTRU receives an AP-CSI triggering command, for example, the WTRU may determine to measure and/or report CSI (e.g., only) for the triggered RS configuration. For example, the NW may trigger an AP-CSI report with private RS configuration (e.g., only), and/or the WTRU may receive (e.g., only) the private RS configuration to measure the CSI and/or calculate the private CSI reporting content part and/or may include the private CSI reporting content part in the CSI report (and/or similarly for the common CSI). If both common and private RS configurations are triggered, for example, the WTRU may measure the CSI and/or may calculate the private and/or common CSI reporting contents, and/or may include both reporting contents in a single CSI report. The configuration information may include a first RS configuration and/or a second RS configuration. The first RS configuration may be associated with the common messages of RS-based transmission. The second RS configuration may be associated with the WTRU-specific messages of RS-based transmission.

In the RS approach, for example, a WTRU may be configured with CSI configuration to optimize performance in multi-user scenarios. CSI may encompass measurements regarding the quality of the radio channel, which may be included for efficient resource allocation and/or interference management. CSI may provide (e.g., essential) feedback regarding the state of the channel between the WTRU and the gNB. A WTRU being configured with CSI configuration may enable the gNB to make informed decisions about resource allocation, power adjustments, and/or scheduling for (e.g., both) common and/or private messages within the RS framework. Accurate CSI may help in managing interference (e.g., effectively), allowing the gNB to separate common and private message transmissions while ensuring minimal impact on data quality.

A WTRU may receive CSI configuration, including one or more of the following.

A WTRU may be configured with an initial power offset (ac) between the allocated power for common and private messages, for example, by RRC. For example, the WTRU may receive configuration information (e.g., including the initial power offset) in a RRC message. The WTRU may apply the power offset for CSI estimation for each of the messages (e.g., estimation of channel quality index (CQI), PMI for the private and/or common messages). The private message may be separate and/or may not be encrypted in the common message. For example, the WTRU may report separate CQI/PMI estimates for the common and private data streams. The WTRU may send one CQI/PMI for common messages and another CQ/PMI for private messages computed based on a power offset+Δ with respect to common messages. A positive offset may mean the CSI associated to the private message is estimated with a higher power level relative to the one of the private messages; a negative offset may mean the opposite (e.g., the CSI associated to the private message is estimated with a lower power relative to the one of the private messages). This Δ value may be determined in gNB based on the following: one or more adaptive power control algorithms and/or an adjustment decision.

This Δ value may be determined in gNB based on one or more adaptive power control algorithms. The WTRU may (e.g., also) receive a dynamic indication (e.g., a DCI to correct the initial power offset). With respect to loop control, adaptive power control protocols can be implemented, where the adjustments may be made in a closed-loop system. This may ensure that the relative power levels between the common and private messages are (e.g., continually) optimized based on ongoing feedback, minimizing excessive power usage while maintaining required service quality and/or mitigating the interference among co-scheduled WTRUs. With respect to propositional power control, adaptive power control algorithms may adjust power based on the difference between the desired signal to noise interference ratio (SINR) and/or the measured SINR.

This Δ value may be determined in gNB based on an adjustment decision. The gNB may receive the CSI and/or other feedback metrics from the WTRUs. For example, the WTRU may transmit the feedback to the gNB at the physical layer (e.g., physical uplink control channel (PUCCH), physical uplink shared channel (PUSCH)). The gNB may process this information to evaluate whether the current power allocation for common and/or private messages is adequate. One or more of the following (e.g., key) considerations may include: interference levels and/or private message Rx quality. With respect to interference levels, if WTRUs report high interference on the common message, for example, the gNB may decide to increase power for that message to ensure reliable communication. The WTRU may be configured with a lower Δ value for the private messages. With respect to private message Rx quality, if a WTRU indicates poor reception quality for its private message, the gNB may choose to increase the power offset specifically for that WTRU's private message to enhance its reception.

In examples, a WTRU may be configured with the two initial power offsets, e. g., (α_{c} and α_{c}′) between the allocated power for common and private messages, where α_{c} may be applicable for CQ estimate and α_{c}′ may applicable for PMI estimate. For example, the WTRU may use different power level to calculate PMI from CQ for (e.g., both) common and/or private messages.

In examples, the WTRU may determine the value of power offset (ac) between the allocated power for common and private messages and/or report it to gNB.

A WTRU may receive CSI report configuration, including one or more of the following.

The WTRU may receive a first and/or a second CSI configuration for the common and/or the private messages, respectively. A WTRU may be configured with a first and/or a second configuration for report quantity, and/or a first and/or a second configuration for CSI resources, etc. For example, in one or more (e.g., some) scenarios that the private messages have higher priority than common messages and the resolution of beam reporting for private messages should be more than the resolution of beam reporting for common messages, the WTRU may report one or more of following CSI quantity combinations: RI-CQI for the common message and RI-PMI-CQI for the private message; RI for the common message and RI-PMI for the private message; RI for the common message and PMI-CQ for the private message; CQ for the common message and RI-CQI for the private message; and/or CQ for the common message and PMI-CQ for the private message. The first CSI configuration may include first CSI report configuration information associated with the first CSI report. The second CSI configuration may include second CSI report configuration information associated with the second CSI report.

The WTRU may determine at least a first CSI feedback based on the first CSI configuration associated with the common messages of RS-based transmission. The WTRU being configured to determine the first CSI feedback may include the WTRU being configured to determine a rank indicator (RI), channel quality indicator (CQ), and/or PMI associated with the common messages of RS-based transmission. The WTRU may determine at least a second CSI feedback based on the second CSI configuration associated with the WTRU-specific messages of RS-based transmission. The WTRU being configured to determine the second CSI feedback may include the WTRU being configured to determine a RI, CQ, and/or a PMI associated with WTRU-specific messages of RS-based transmission.

In examples, in one or more (e.g., some) scenarios the common message may have higher priority than private messages and/or the resolution of beam reporting for common messages should be more than the resolution of beam reporting for private messages, the WTRU may report one or more of the following CSI quantity combinations: RI for the private message and RI-PMI for the common message; RI for the private message and PMI-CQI for the common message; CQ for the private message and RI-CQI for the common message; and/or CQ for the private message and PMI-CQI for the common message. One example of this scenario may happen when one or more (e.g., multiple) users request a popular live sport event. In this case, the common messages may have higher priority than private messages.

In examples, in one or more (e.g., some) scenarios that the private messages are more important than common messages, the WTRU may report CSI for the common message aperiodically, while the WTRU may report CSI for the private message periodically. For example, the report quantity such as RI-PMI-CQI may get updates more frequently. This may provide a mechanism for gNB to perform beam management with more accurate beams for private data streams.

In examples, in one or more (e.g., some) scenarios such as when one or more (e.g., multiple) users request a popular live sport event, the WTRU may report CSI for the private message aperiodically, while the WTRU may report CSI for the common message periodically. For example, the report quantity such as RI-PMI-CQI may get updates more frequently for the common messages. This may provide a mechanism for gNB to perform beam management with more accurate beams for common data streams.

In examples, in the RS approach, the common message portion and/or the private message portion of the message signal may be transmitted based on at least one of the following.

The common message portion and/or the private message portion of the message signal may be transmitted based on the same spatial domain (SD) basis vector and/or beam but different layers and/or streams. For example, a first SD basis vector may be used for transmission of two or more layers (e.g., a first layer and a second layer). The common portion of the message signal may be transmitted using the second layer.

The common message portion and/or the private message portion of the message signal may be transmitted based on different SD basis vectors. For example, a first SD basis vector may be used for transmission of one or more layers and/or a second SD basis vector may be used for transmission of one or more layers. The common portion may be transmitted using one or more layers transmitted through the first SD basis vector and/or the private portion may be transmitted using one or more layers transmitted using the second SD basis vector.

Since the resources (e.g., time and/or frequency resources) that are used for transmission of the common part may be common for two or more WTRUs in a group of WTRUs, grouped for the RS reception, transmission of the common part may be carried out on wider beam(s) to accommodate and/or to serve the WTRUs in the group of WTRUs. Embodiments may include methods and/or procedures to determine a CSI for transmission of the common part using different SD basis vectors.

In examples, a WTRU may receive a semi-static and/or dynamic (e.g., by RRC, MAC-CE, and/or DCI) indication(s) related to codebook parameter(s) and/or codebook configuration that may include one or more of the following. The WTRU may receive a first codebook sub-configuration for determining a PMI for the private message. The configuration may include one or more of the following: a number and/or indexes of a first set of CSI-RS ports, and/or a first DFT oversampling value. The WTRU may receive a second codebook sub-configuration for determining a PMI for the common message. The configuration may include one or more of the following: a number and/or indexes of a second set of CSI-RS ports, and/or a second DFT oversampling value.

The first and/or second codebook sub-configurations may satisfy one or more of the following.

The first sub-configuration and the second sub-configuration may have zero or more common CSI-RS antenna ports.

The first sub-configuration and the second sub-configuration may have the same and/or different oversampling values. For example, the second oversampling value may be lower than the first oversampling value. A second oversampling value that may be lower than the first oversampling value helps with generating a wider beam as compared to a beam generated using the first oversampling value.

The candidate values for the second oversampling value may be higher and/or spaced finer as compared to the candidate values for the first oversampling value.

In examples, the CSI-RS resources for determination of the CSI for the common message and/or the private message may be configured as follows.

The WTRU may receive a CSI-RS resource set configuration, that includes a first CSI-RS resources for determining a CSI for private message portion and/or a second CSI-RS resource for determining a CSI for common message portion. For example, the first CSI-RS resource may be mapped to 24 CSI-RS antenna ports, and/or the second CSI-RS resource may be mapped to 8 CSI-RS antenna ports. For example, the first 24 CSI-RS antenna ports may be mapped to the first CSI-RS resource and/or the remaining 8 CSI-RS antenna ports may be mapped to the second CSI-RS resource. For example, the first and/or the second CSI-RS resource may have the same 32 antenna ports.

The CSI-RS resource set may have one or more semi-static and/or dynamic indications for configuring power-related parameters. The CSI-RS resource set may have an associated indication for a first power level that may represent the energy and/or power level of the transmitted CSI-RS resource, e.g., powerControlOffsetss value and/or a second power level that may be the power level determination (e.g., assumption) of the (e.g., hypothetical) physical downlink shared channel (PDSCH) that the WTRU may use to determine a CSI (e.g., powerControlOffset). For example, the first CSI-RS resource and/or the second CSI-RS resource in the CSI-RS resource set may have a single first power level value and/or a single second power level value. One or more CSI-RS resources in the CSI-RS resource set may have associated indications for first power level, e.g., powerControlOffset and/or a second power level (e.g., powerControlOffsetss). For example, the first and/or the second CSI-RS resource in the CSI-RS resource set may have a single first power level value and/or a single second power level value.

The first CSI-RS resource may be used to determine a first CSI, and/or the second RS resource may be used to determine a second CSI. The first CSI-RS resource may be used by the WTRU(s) as an interference measurement resource (IMR) for measuring interference caused by the CSI-RS antenna ports mapped to the first CSI-RS resource to the antenna elements and/or antenna ports used for reception of the common message. The second CSI-RS resource may be used by the WTRU(s) as an interference measurement resource (IMR) for measuring interference caused by the CSI-RS antenna ports mapped to the second CSI resource to the antenna elements and/or antenna ports used for reception of the private message.

In examples, the WTRU may determine a first CSI based on the first CSI-RS resource for the private message portion and/or a second CSI based on the second CSI-RS resource for the common message portion. The first and/or the second CSIs may be inter-dependent and/or independent. For example, the WTRU may determine a first PMI based on the first CSI-RS resource and/or a second PMI based on the second CSI-RS resource and/or based on the first PMI (e.g., the second PMI may be selected from a subset of SD basis vector in the codebook of SD basis vector associated with the second CSI-RS resource where the selected subset of SD basis vectors may be the one that are orthogonal to the first PMI and/or first SD basis vectors in one or more dimensions).

In examples, the WTRU may determine a second CSI based on the second CSI-RS resource for the common message portion and/or a first CSI based on the first CSI-RS resource for the private message portion. The first and/or the second CSIs may be inter-dependent and/or independent. For example, the WTRU may determine a second PMI based on the second CSI-RS resource and/or a first PMI based on the first CSI-RS resource and/or based on the second PMI. For example, the first PMI may be selected from a subset of SD basis vector in the codebook of SD basis vector associated with the first CSI-RS resource where the selected subset of SD basis vectors may be the one that are orthogonal to the second PMI and/or second SD basis vectors in one or more dimensions.

In examples, the WTRU may receive a semi-static and/or dynamic indication to change and/or adjust the first and/or second oversampling value(s). The periodicity of adjusting the second oversampling may be higher, equal, or lower as compared to the periodicity of adjusting the first oversampling value.

In examples, the WTRU may send a CSI report that may include indications for indicating CSI related to the common portion of the message and/or private portion of the message. The indications related to the common portion of the message may be reported with a higher priority as compared to the private portion. For example, the WTRU may transmit at least one CSI report. The at least one CSI report may include the at least first CSI feedback and/or the at least second CSI feedback. The at least one CSI report may include a first CSI report and/or a second CSI report. The first CSI report may include the at least first CSI feedback. The second CSI report may include the at least second CSI feedback. The WTRU being configured to transmit the at least one CSI report may include the WTRU being configured to transmit the first CSI report based on the first CSI report configuration. The WTRU being configured to transmit the at least one CSI report may include the WTRU being configured to transmit the second CSI report based on the second CSI report configuration. The WTRU being configured to transmit the first CSI feedback may include the WTRU being configured to transmit an indication that indicates a first subset of spatial-domain basis vectors and/or beam combining coefficients associated with the common messages of RS-based transmission. The WTRU being configured to transmit the second CSI feedback may include the WTRU being configured to transmit an indication that indicates second subset of spatial-domain basis vectors and/or beam combining coefficients associated with the WTRU-specific messages of RS-based transmission. The first CSI report may be associated with a first PMI codebook. The second CSI report may be associated with a second PMI codebook. The WTRU being configured to transmit the first CSI report may include the WTRU being configured to transmit an indication that indicates the first PMI codebook (e.g., from a first codebook). The WTRU being configured to transmit the second CSI report may include the WTRU being configured to transmit an indication that indicates the second PMI codebook (e.g., from a second codebook). The at least one CSI report may be transmitted based on the power offset. For example, the WTRU may transmit the (e.g., CSI) feedback to the gNB at the physical layer (e.g., physical uplink control channel (PUCCH), physical uplink shared channel (PUSCH)).

In examples, the WTRU may report wideband PMI for the common message, and/or subband PMI for the private messages. The WTRU may be configured with a rule to report subband PMIs for the private messages.

In examples, the WTRU may be configured with a threshold for the number of subbands,

$${N}_{s u b}^{t h} < {N}_{s u b} ,$$

where N_{sUb} may be the total number of sub bands. Based on this threshold, for example, the WTRU may determine a mechanism for the report quantity including at least

$${N}_{s u b}^{t h}$$

Subband PMI(s) to report. If the WTRU is configured to report at least

$${N}_{s u b}^{t h} and {N}_{s u b}^{t h} < \frac{{N}_{s u b}}{2} ,$$

the report quantity may include the subband PMI(s) for (e.g., only) the even and/or odd sub-bands. If the WTRU is configured to report at least

$${N}_{s u b}^{t h} and {N}_{s u b}^{t h} \geq \frac{{N}_{s u b}}{2} ,$$

the WTRU may randomly select

$${N}_{s u b}^{t h}$$

sub bands to calculate subband PMI(s) and/or the WTRU may calculate one or more (e.g., all) subband PMI(s) for N_{sub} sub bands and/or may select the best

$${N}_{s u b}^{t h}$$

sub band(s) for the report quantity.

In examples, the WTRU may be configured with two thresholds: a first threshold for the number of subbands,

$${N}_{s u b}^{t h} < {N}_{s u b} ,$$

where N_{sub} may be the total number of subbands; and/or a second threshold for the maximum sub bands distance among a per of reported subband

$${M}_{s u b}^{t h} .$$

Since in one or more (e.g., some) scenarios (e.g., time varying channel) the channel may vary (e.g., may vary fast), the gNB may require the report of at least

$${N}_{s u b}^{t h}$$

that are not next to each other from N_{sub} is to be provided. Based on

$${N}_{s u b}^{t h} and / or {M}_{s u b}^{t h} ,$$

the WTRU may determine a report quantity as follows. For example, the WTRU may (e.g., first) select

$$[ \frac{{N}_{sub}}{{M}_{sub}^{t h}} ]$$

sub bands with

$${M}_{s u b}^{t h}$$

distance from

$${N}_{sub}^{t h}$$

sub band. The WTRU may randomly select the other

$${N}_{sub}^{t h} - [ \frac{{N}_{sub}}{{M}_{sub}^{t h}} ]$$

sub bands from the

$${N}_{sub} - [ \frac{{N}_{sub}}{{M}_{sub}^{th}} ]$$

left sub bands. In examples, the WTRU may (e.g., first) select

$$[ \frac{{N}_{sub}}{{M}_{sub}^{th}} ]$$

sub bands with

$${M}_{sub}^{th}$$

distance from

$${N}_{s u b}^{t h}$$

sub band. The WTRU may (e.g., then) select the first

$${N}_{sub}^{th} - [ \frac{{N}_{sub}}{{M}_{sub}^{th}} ]$$

sub bands from the

$${N}_{sub} - [ \frac{{N}_{sub}}{{M}_{sub}^{th}} ]$$

left sub bands.

The WTRU may report a (e.g., CSI) phase factor to orthogonalize and/or semi-orthogonalize the PMIs between the private and common messages based on one or more of the following. The WTRU may calculate the PMI of the common and/or private message. The WTRU may calculate the PMI of the private and/or common message considering a phase factor is such a way that the two PMIs to be orthogonal and/or semi-orthogonal. The WTRU may (e.g., separately) calculate the PMI of the common and/or private messages. The WTRU may calculate a phase factor in such a way that two PMIs to be orthogonal and/or semi-orthogonal. The WTRU may jointly calculate the PMI of the common and private messages associated with a phase factor in such a way that the two PMIs to be orthogonal and/or semi-orthogonal. The (e.g., CSI) phase factor may be indicative of the orthogonality between the common messages PMI and the WTRU-specific PMI. The (e.g., CSI) phase factor may be configured to maintain and/or maximize orthogonality between the common messages PMI and the WTRU-specific PMI.

For common messages, which may be shared among one or more (e.g., multiple) users, the WTRU may measure the channel conditions based on the CSI-RS and/or may select a PMI corresponding to the common codebook used by the gNB. This PMI may be chosen in such a way that it allows one or more (e.g., multiple) WTRUs to decode the common message orthogonally. The WTRU may report a common PMI that is designed to be effective for one or more (e.g., all) users receiving the common message, which may help ensure that the precoding chosen does not cause interference among the users. Each WTRU may, additionally or alternatively, measure its own channel conditions for the private message. The WTRU may select a private PMI based on, for example, its unique channel response to the specific signal directed at it. The private PMIs reported by individual WTRUs may be tailored for their unique channel conditions and/or may help maintain orthogonality and/or semi-orthogonality with the common message. The WTRU may report a phase factor for each layer to orthogonalize and/or semi-orthogonalize the PMIs between the private and common messages. The at least one CSI report may include at least one CSI phase factor between a common messages PMI associated with the common messages of RS-based transmission and a WTRU-specific PMI associated with the WTRU-specific messages of RS-based transmission. The at least one CSI phase factor may be indicative of the orthogonality between the common messages PMI and the WTRU-specific PMI. The WTRU being configured to transmit the first CSI feedback may include the WTRU being configured to transmit an indication indicating the common messages PMI. The WTRU being configured to transmit the second CSI feedback may include the WTRU being configured to transmit an indication indicating the WTRU-specific messages PMI. The WTRU being configured to transmit the at least one CSI report may include the WTRU being configured to transmit an indication indicating the at least one CSI phase factor. For example, the WTRU may transmit the feedback to the gNB at the physical layer (e.g., physical uplink control channel (PUCCH), physical uplink shared channel (PUSCH)).

For CSI reporting of common and/or private messages, different combination CSI quantity per reporting may be considered. For example, configured CSI quantities may be one or more of LI, RI, PMI, and/or CQ. In examples, one or more of the following may be used.

A first CSI report may include (e.g., all) the configured CSI quantities for the common message, and/or a second CSI report may include (e.g., all) the configured CSI quantities for the private message. For example, a first CSI report may include a first set of LI, RI, PMI, and/or CQ for the common message, and/or a second set of LI, RI, PMI, and/or CQ for the private message. A first CSI report may include a first subset of configured CSI quantities for the common and/or private messages, and/or a second CSI report may include a second subset of configured CSI quantities. For example, the first CSI report may include PMI and/or CQ information for the common and/or private messages; the second CSI report may include RI for the common and/or private messages.

Embodiments described herein may include codebook modes and/or PMI design for common and/or private messages. When a same codebook is used for common and private messages, for example, the WTRU may perform one or more of the following. The WTRU may report a first subset of spatial-domain basis vectors and/or beam-combining coefficients for the common message, and/or a second subset of spatial-domain basis vectors and/or beam-combining coefficients for the private message. The WTRU may report a single subset of spatial-domain basis vectors for (e.g., both) common and/or private messages, and/or two separate subsets of beam-combining coefficients for the common message and private message, respectively.

The initial codebook configuration(s) may be communicated to the WTRU through RRC messages. During connection establishment and/or reconfiguration, the gNB may send parameters that refer to how the codebooks may be used for (e.g., both) common and/or private messages. The parameters may include codebook type (e.g., the determination of codebook type can be based on different channel conditions, varying levels of interference, etc.) and/or specific codebook index (e.g., the specific index and/or selection from the overall codebook that may be used for each type of message—common and/or private messages). The gNB may use a common codebook shared among one or more (e.g., multiple) users for the common message. This design may help ensure that the common beamforming can be correctly decoded by one or more (e.g., all) intended recipients regardless of their position and/or channel conditions. To reduce the feedback overhead, the same codebook may, additionally or alternatively, be used for the private messages for one or more (e.g., all) WTRUs. A mechanism may be introduced to consider the performance and/or feedback overhead cost among WTRUs.

In examples, the WTRU may report a first subset of SD basis vectors and/or beam-combining coefficients for the common message, and/or a second subset of SD basis vectors and/or beam-combining coefficients for the private message in such a way that the first subset and the second subset to be orthogonal. This may increase the WTRU computational cost to find the orthogonal subset of SD basis. To reduce the computational cost, the WTRU may randomly select any subset of SD basis vectors and/or beam combining coefficients regardless of orthogonality of beams.

In examples to reduce the feedback overhead, the WTRU may report a single subset of SD basis vectors for (e.g., both) common and/or private messages, and/or two separate subsets of beam-combining coefficients for the common message and private message, respectively. In examples, the WTRU may report two subsets of SD basis vectors for (e.g., both) common and/or private messages, and/or one single subset of beam-combining coefficients for the common message and private message, respectively.

In examples, a WTRU may be configured with two different codebooks for the private and common messages, where different number of ports may be configured for each message. For example, the WTRU may be configured with 2 N₁N₂≤N_{TC} ports for common messages, where N₁ and N₂ may be the number of antenna ports in horizontal and vertical directions, respectively, and/or N_{TC}={16, 32}. The WTRU may be configured with 2 N₁N₂≤N_{TP} ports for common private, where N_{TP}={128, 64}, since the private messages may require high resolution beams.

In examples, since the common messages may have high priority in one or more (e.g., some) scenarios, the WTRU may be configured with 2 N₁N₂≤N_{TC} ports for common messages, where N_{TC}={128,64}. The WTRU may be configured with 2 N₁N₂≤N_{TP} ports for private messages, where N_{TP}={16, 32}.

In examples, to provide a beam with higher resolution for private messages, the WTRU may be configured with Type II codebook for common messages and/or with Type I for private messages. In examples, in one or more (e.g., some) scenarios with high priority for common messages, the WTRU may be configured with Type I codebook for private messages and/or with Type II for private messages. In examples, to reduce the feedback overhead, the WTRU may be configured with codebook mode 2 for common messages, where the WTRU may provide feedback in terms of RI, CQ, and/or partial PMI; the WTRU may be configured with codebook mode 1 for private messages. In examples, in one or more (e.g., some) scenarios with high priority for common messages and/or feedback overhead reduction, the WTRU may be configured with codebook mode 2 for (e.g., both) private and/or common messages.

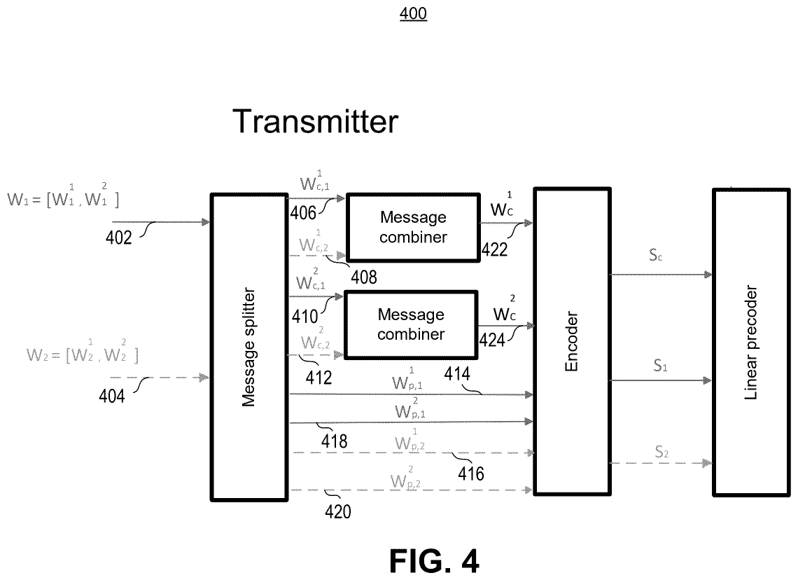

In examples, a WTRU may be configured with one or more (e.g., some) layers with the RS approach and/or the others with MIMO layers. For example, the WTRU may be configured with the number of co-scheduled WTRUs (e.g., and/or with maximum Lₘₐₓ layers). The WTRU may report to support the RS approach for (e.g., only) L_{RS} layers, e.g., Lₘₐₓ-L_{RS} layers may be received with MIMO layers. In examples, the WTRU may be configured with a same and/or different codebook for common and/or private messages on L_{RS} layers and/or a same and/or different codebook on Lₘₐₓ-L_{RS} layers. For example, a WTRU may report Kₘₐₓ=2 and/or L_{RS}=Lₘₐₓ=2, by which two WTRUs, each with two MIMO layers, may be co-scheduled for a downlink RSMA transmission. The WTRU may be configured with Kₘₐₓ=2 and Lₘₐₓ=2, as shown in FIG. 4.

FIG. 4 depicts an example of rate-splitting (RS) layers 400 at transmitter.

$${W}_{i}^{j}$$

may refer to the jth message of user-i. In examples, the two data streams, e.g., W₁ 402 and/or W₂ 404 may be split into one or more (e.g., four) messages as shown herein:

$${W}_{1}^{1} = \{ {W}_{c , 1}^{1} , {W}_{p , 1}^{1} \} ; {W}_{1}^{2} = \{ {W}_{c , 1}^{2} , {W}_{p , 1}^{2} \} ; {W}_{2}^{1} = \{ {W}_{c , 2}^{1} , {W}_{p , 2}^{1} \} ; \\ and / or \\ {W}_{2}^{2} = \{ {W}_{c , 2}^{2} , {W}_{p , 2}^{2} \} \cdot {W}_{c , 1}^{1}$$

406 and

$${W}_{c , 2}^{1}$$

408 may be the common part of layer 1 from user 1 and user 2, respectively;

$${W}_{c , 1}^{2}$$

410 and

$${W}_{c , 2}^{2}$$

412 may be the common part of layer 2 from user 1 and user 2, respectively;

$${W}_{p , 1}^{1}$$

414 and

$${W}_{p , 2}^{1}$$

416 may be the private part of layer 1 from user 1 and user 2, respectively, and/or,

$${W}_{p , 1}^{2}$$

418 and

$${W}_{p , 2}^{2}$$

420 may be the private part of layer 2 from user 1 and user 2, respectively. As shown in FIG. 4, the common part of layer 1 from user 1 and user 2, e.g.,

$${W}_{c , 1}^{1}$$

406 and

$${W}_{c , 2}^{1}$$

408 may be combined as

$${W}_{c}^{1}$$

422. Similarly, for layer 2, the common part from user 1 and user 2 may be combined as

$${W}_{c}^{2}$$

424. In examples, the WTRU may report a first subset of spatial-domain basis vectors and/or beam-combining coefficients for the common message, and/or a second subset of spatial-domain basis vectors and/or beam-combining coefficients for the private message. Additionally or alternatively, the WTRU may report a single subset of spatial-domain basis vectors for (e.g., both) common and/or private messages, and/or two separate subsets of beam-combining coefficients for the common message and privates' message, respectively.

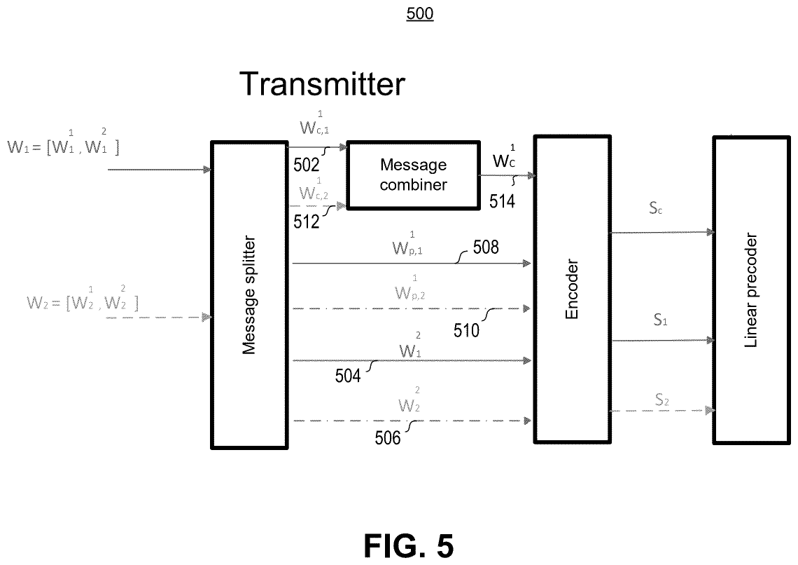

FIG. 5 depicts an example of RS and non-RS layers at transmitter 500.

In examples, a WTRU may report Kₘₐₓ=2 and/or Lₘₐₓ=2, by which 2 WTRUs, each with 2 MIMO layers, may be co-scheduled for a downlink RSMA transmission. The UE may be configured with Kₘₐₓ=2 and/or Lₘₐₓ=2 as shown in FIG. 5, where

$${W}_{i}^{j}$$

may refer to the jth message of user-i. In examples, the two data streams, e.g., W₁ and/or W₂ may be split into one or more (e.g., four) messages as shown herein:

$${W}_{1}^{1} = \{ {W}_{c , 1}^{1} , {W}_{p , 1}^{1} \} ; {W}_{1}^{2} = \{ {W}_{1}^{2} \} ; {W}_{2}^{1} = \{ {W}_{c , 2}^{1} , {W}_{p , 2}^{1} \} ; and / or {W}_{2}^{2} = \{ {W}_{2}^{2} \} . {W}_{c , 1}^{1}$$

502 may be the common part of layer 1 from user 1,

$${W}_{1}^{2}$$

504 and

$${W}_{2}^{2}$$

506 may be the data stream e.g., without the RS approach) for user 1 and user 2, respectively;

$${W}_{p , 1}^{1}$$

508 and

$${W}_{p , 2}^{1}$$

510 may be the private part of layer 1 from user 1 and user 2, respectively;

$${W}_{c , 1}^{1}$$

502 and

$${W}_{c , 2}^{1}$$

512 may be the common part of layer 1 from user 1 and user 2, respective. As it can be seen from FIG. 5, the common art of layer 1 from user 1 and user 2, e.g.,

$${W}_{c , 1}^{1}$$

502 and

$${W}_{c , 2}^{1}$$

512 may be combined as

$${W}_{c}^{1}$$

514.

In examples, the WTRU may report as follows. For layer 1 (e.g., with the RS approach), the WTRU may report a first subset of spatial-domain basis vectors and/or beam-combining coefficients for the common message, and/or a second subset of spatial-domain basis vectors and beam-combining coefficients for the private message. For layer 2 (with the non-RS approach), the WTRU may report a first subset of spatial-domain basis vectors and/or beam-combining coefficients and/or a second subset of spatial-domain basis vectors and/or beam-combining coefficients. In examples, for layer 2 (e.g., with the non-RS approach), the WTRU may report a single subset of spatial-domain basis vectors and/or two separate subsets of beam-combining coefficients.

Additionally or alternatively, for layer 1, the WTRU may report a single subset of spatial-domain basis vectors for (e.g., both) common and/or private messages, and/or two separate subsets of beam-combining coefficients for the common message and privates' message, respectively. For layer 2 (e.g., with the non-RS approach), the WTRU may report a single subset of spatial-domain basis vectors and/or two separate subsets of beam-combining coefficients. In examples, for layer 2 (e.g., with the non-RS approach), the WTRU may report a first subset of spatial-domain basis vectors and/or beam-combining coefficients and/or a second subset of spatial-domain basis vectors and/or beam-combining coefficients.

In one or more (e.g., some) scenarios, the WTRU may be configured with a codebook subset restriction (CBSR) by DCI and/or RRC, to limit the search space for reporting SD basis vector for common and/or private messages. For example, the WTRU may receive configuration information (e.g., including the CBSR) in a RRC message. This restriction may be designed by gNB and/or the WTRU to reduce the feedback overhead. In examples, the WTRU may receive a subset from the first subset of spatial-domain basis vectors and/or beam-combining coefficients for the common message and/or may receive another subset of the second subset of spatial-domain basis vectors and/or beam-combining coefficients for the private message. For example, the CBSR may be different for common and private messages to provide a beam with higher resolution for private messages. In examples, the WTRU may receive a subset from the first subset of spatial-domain basis vectors for (e.g., both) common and/pr privates' messages, and/or two separate subsets of beam-combining coefficients for the common message and/or private message, respectively. For example, the CBSR may be the same for common and private messages.

In examples, the WTRU may select a CSBR for spatial-domain basis vectors and/or beam-combining coefficients for (e.g., both) common and/or private data messages. The WTRU may report the CBSR to gNB and/or may perform beam selection from the subset restriction (e.g., only) when the confirmation of CBSR is received.

In examples, a WTRU may be configured to report partial CSI for one of the common and/or private messages. The gNB may determine the corresponding CSI quantity for a second message from the reported quantity for the first message. For example, a WTRU may estimate and/or report the CQ for the common message. The gNB may infer the CQ for the private message based on the reported CQ and/or the configured delta value, e.g., Δ(α_{c}). In examples, a WTRU may be configured to report PMI (e.g., only) for the private message, and/or may determine (e.g., assume) an open-loop, e.g., random precoding for the common message. A WTRU may determine (e.g., assume) a same subband size for the common message as configured for the private message.

Based on the RS approach, for example, methods of CSI configuration and/or CSI reporting may included in the embodiments described herein. In examples, the gNB may serve 2 users with single layer.

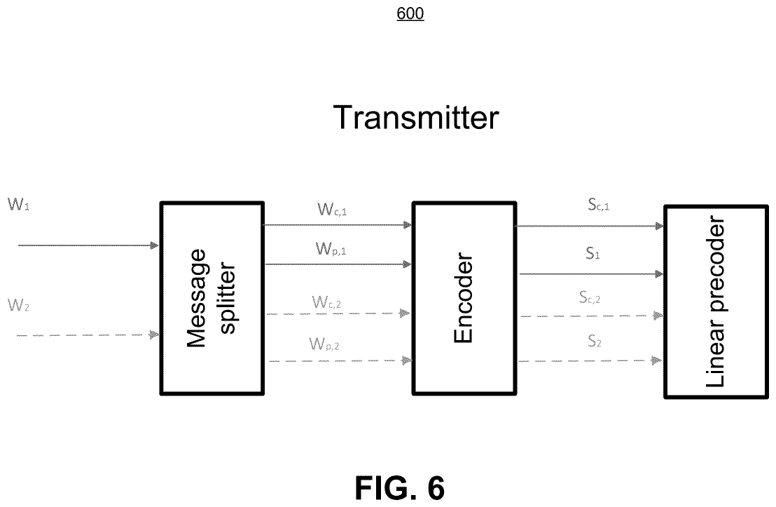

FIG. 6 depicts an example of RS with a common part and a private part for two users 600. The transmitter may split the message into a common part and a private part as shown in FIG. 6, where W may be the data stream of i^{th} user splitting into the common part, e.g., W_{c,i} and/or the private part, e.g., W_{p,i} and i={1,2}. This may mean that 2 users receive the common part in a common stream and the private part in a private stream that are superposed in a non-orthogonal manner. The common stream may be decodable by 2 users; the private stream may (e.g., only) be decodable by the intended user.

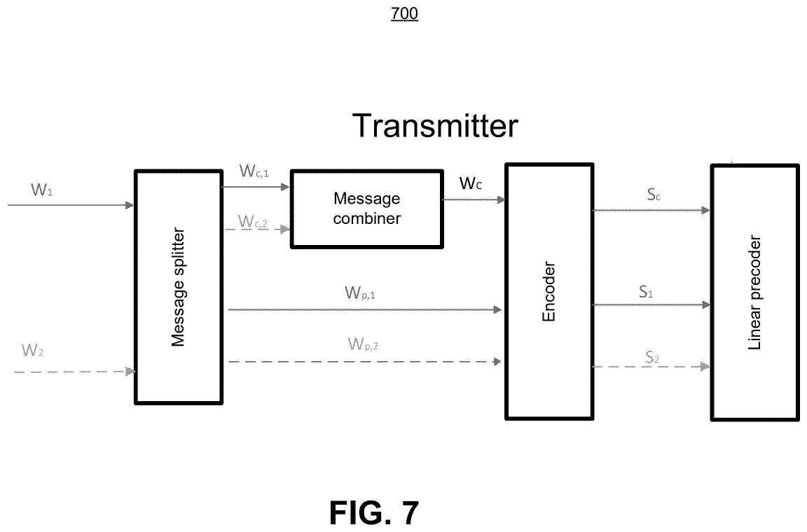

FIG. 7 depicts an example RS with a common and a private portion for two users 700 and a message combiner. The common streams of two users can be (e.g., also) combined and/or each WTRU may decode the combination of common messages, as shown in FIG. 7.

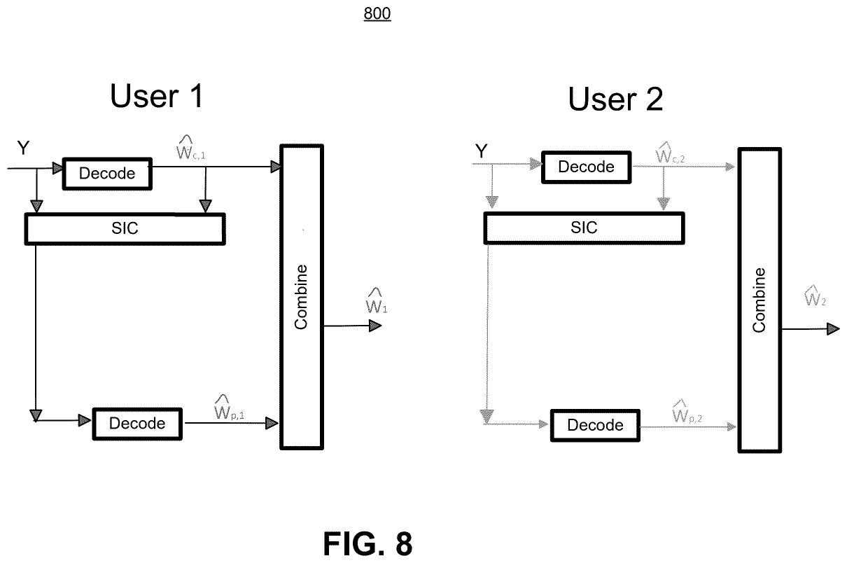

At the receiver side, each WTRU may (e.g., first) decode the common data streams of one or more (e.g., all) users using SIC. Each WTRU may (e.g., then) decode its own private data stream by treating the interference as noise. Each WTRU may (e.g., then) combine its own common and private messages to decode its own data stream. FIG. 8 shows the receiver architecture with the RS approach for User 1 and User 2 800.

In examples, the WTRU may receive CSI configuration, including an initial power offset (ac) between the allocated power for common and private messages, and/or a first and/or a second CSI configuration for the common and the private messages, respectively. Each WTRU may be configured with different codebooks for common and private messages. Each WTRU may be configured with a different report quantity for each common and/or private messages. For example, WTRU 1 may report (e.g., only) PMI for private messages while the WTRU 1 may report CQ and/or RI for common messages; WTRU 2 may report (e.g., only) CQ for private messages and/or may report RI and PMI for common messages.

In examples, WTRU 1 may report a first subset of spatial-domain basis vectors and/or beam-combining coefficients for the common message, and/or a second subset of spatial-domain basis vectors and/or beam-combining coefficients for the private message, while WTRU 2 may report a single subset of spatial-domain basis vectors for (e.g., both) common and/or privates messages, and/or two separate subsets of beam-combining coefficients for the common message and private message, respectively.

A base station may send configuration information. The configuration information may include a first CSI configuration and/or a second CSI configuration. The first CSI configuration may be associated with reception of common messages of RS-based transmission. The second CSI configuration may be associated with WTRU-specific messages of RS-based transmission. The base station may receive at least one CSI report. The at least one CSI report may include at least first CSI feedback and/or at least second CSI feedback. The at least first CSI feedback may be determined based on the first CSI configuration associated with the common messages of RS-based transmission. The at least second CSI feedback may be determined based on the second CSI configuration associated with the WTRU-specific messages of RS-based transmission.

1. A wireless transmit/receive unit (WTRU) comprising:
a processor configured to:
receive configuration information, wherein the configuration information comprises a first channel state information (CSI) configuration and a second CSI configuration,
wherein the first CSI configuration is associated with reception of common messages of rate splitting-based (RS-based) transmission, and wherein the second CSI configuration is associated with reception of WTRU-specific messages of RS-based transmission;
determine at least a first CSI feedback based on the first CSI configuration associated with the common messages of RS-based transmission;
determine at least a second CSI feedback based on the second CSI configuration associated with the WTRU-specific messages of RS-based transmission; and
transmit at least one CSI report, the at least one CSI report comprising the at least first CSI feedback and the at least second CSI feedback.

2. The WTRU of claim 1, wherein the at least one CSI report comprises a first CSI report and a second CSI report, wherein the first CSI report comprises the at least first CSI feedback, and wherein the second CSI report comprises the at least second CSI feedback.

3. The WTRU of claim 2, wherein the first CSI configuration comprises first CSI report configuration information associated with the first CSI report, and wherein the second CSI configuration comprises second CSI report configuration information associated with the second CSI report, and wherein the processor being configured to transmit the at least one CSI report comprises the processor being configured to transmit the first CSI report based on the first CSI report configuration information, and wherein the processor being configured to transmit the at least one CSI report comprises the processor being configured to transmit the second CSI report based on the second CSI report configuration information.

4. The WTRU of claim 2, wherein the processor being configured to transmit the first CSI feedback comprises the processor being configured to transmit an indication that indicates a first subset of spatial-domain basis vectors or beam combining coefficients associated with the common messages of RS-based transmission, and wherein the processor being configured to transmit the second CSI feedback comprises the processor being configured to transmit an indication that indicates a second subset of spatial-domain basis vectors or beam combining coefficients associated with the WTRU-specific messages of RS-based transmission.

5. The WTRU of claim 4, wherein the first CSI report is associated with a first precoding matrix indicator (PMI) codebook, and wherein the second CSI report is associated a second PMI codebook, and wherein the processor being configured to transmit the first CSI report comprises the processor being configured to transmit an indication that indicates the first PMI codebook from a first codebook, and wherein the processor being configured to transmit the second CSI report comprises the processor being configured to transmit an indication that indicates the second PMI codebook from a second codebook.

6. The WTRU of claim 4, wherein the processor being configured to determine the first CSI feedback comprises the processor being configured to determine a rank indicator (RI), channel quality indicator (CQ), or PMI associated with the common messages of RS-based transmission, and
wherein the processor being configured to determine the second CSI feedback comprises the processor being configured to determine a RI, CQ, or PMI associated with WTRU-specific messages of RS-based transmission.

7. The WTRU of claim 1, wherein the at least one CSI report comprises at least one CSI phase factor between a common messages precoding matrix indicator (PMI) associated with the common messages of RS-based transmission and a WTRU-specific PMI associated with the WTRU-specific messages of RS-based transmission, wherein the at least one CSI phase factor is indicative of the orthogonality between the common messages PMI and the WTRU-specific PMI.

8. The WTRU of claim 7, wherein the processor being configured to transmit the first CSI feedback comprises the processor being configured to transmit an indication indicating the common messages PMI, and wherein the processor being configured to transmit the second CSI feedback comprises the processor being configured to transmit an indication indicating the WTRU-specific PMI, and wherein the processor configured to transmit the at least one CSI report comprises the processor being configured to transmit an indication indicating the at least one CSI phase factor.

9. The WTRU of claim 1, wherein the configuration information comprises a first RS configuration and a second RS configuration, wherein the first RS configuration is associated with the common messages of RS-based transmission, and wherein the second RS configuration is associated with the WTRU-specific messages of RS-based transmission.

10. The WTRU of claim 1, wherein the configuration information comprises a power offset between the common messages of RS-based transmission and the WTRU-specific messages of RS-based transmission, and wherein the at least one CSI report is transmitted based on the power offset.

11. A method performed by a wireless transmit/receive unit (WTRU), the method comprising:
receiving configuration information, wherein the configuration information comprises a first channel state information (CSI) configuration and a second CSI configuration, wherein the first CSI configuration is associated with reception of common messages of rate splitting-based (RS-based) transmission, and wherein the second CSI configuration is associated with reception of WTRU-specific messages of RS-based transmission;
determining at least a first CSI feedback based on the first CSI configuration associated with the common messages of RS-based transmission;
determining at least a second CSI feedback based on the second CSI configuration associated with the WTRU-specific messages of RS-based transmission; and
transmitting at least one CSI report, the at least one CSI report comprising the at least first CSI feedback and the at least second CSI feedback.

12. The method of claim 11, wherein the at least one CSI report comprises a first CSI report and a second CSI report, wherein the first CSI report comprises the at least first CSI feedback, and wherein the second CSI report comprises the at least second CSI feedback.

13. The method of claim 12, wherein the first CSI configuration comprises first CSI report configuration information associated with the first CSI report, and wherein the second CSI configuration comprises second CSI configuration information associated with the second CSI report, and wherein transmitting the at least one CSI report comprises transmitting the first CSI report configuration based on the first CSI report configuration information, and wherein transmitting the at least one CSI report comprises transmitting the second CSI report configuration based on the second CSI report configuration information.

14. The method of claim 12, wherein transmitting the first CSI feedback comprises the transmitting an indication that indicates a first subset of spatial-domain basis vectors or beam combining coefficients associated with the common messages of RS-based transmission, and wherein transmitting the second CSI feedback comprises transmitting an indication that indicates a second subset of spatial-domain basis vectors or beam combining coefficients associated with the WTRU-specific messages of RS-based transmission.

15. The method of claim 14, wherein the first CSI report is associated with a first precoding matrix indicator (PMI) codebook, and wherein the second CSI report is associated second PMI codebook, and wherein transmitting the first CSI report comprises transmitting an indication that indicates the first PMI codebook from a first codebook, and wherein transmitting the second CSI report comprises transmitting an indication that indicates the second PMI codebook from a second codebook.

16. The method of claim 14, wherein determining the first CSI feedback comprises the determining a rank indicator (RI), channel quality indicator (CQ), or PMI associated with the common messages of RS-based transmission, and
wherein determining the second CSI feedback comprises determining a RI, CQ, or PMI associated with WTRU-specific messages of RS-based transmission.

17. The method of claim 11, wherein the at least one CSI report comprises at least one CSI phase factor between a common messages precoding matrix indicator (PMI) associated with the common messages of RS-based transmission and a WTRU-specific PMI associated with the WTRU-specific messages of RS-based transmission, wherein the at least one CSI phase factor is indicative of the orthogonality between the common messages PMI and the WTRU-specific PMI.

18. The method of claim 17, wherein transmitting the first CSI feedback comprises transmitting an indication indicating the common messages PMI, and wherein transmitting the second CSI feedback comprises transmitting an indication indicating the WTRU-specific PMI, and transmitting the at least one CSI report comprises transmitting an indication indicating the at least one CSI phase factor.

19. The method of claim 11, wherein the configuration information comprises a first RS configuration and a second RS configuration, wherein the first RS configuration is associated with the common messages of RS-based transmission, and wherein the second RS configuration is associated with the WTRU-specific messages of RS-based transmission.

20. The method of claim 11, wherein the configuration information comprises a power offset between the common messages of RS-based transmission and the WTRU-specific messages of RS-based transmission, and wherein the at least one CSI report is transmitted based on the power offset.

21. A base station comprising:
a transceiver; and
a processor configured to:
send, via the transceiver, configuration information, wherein the configuration information comprises a first channel state information (CSI) configuration and a second CSI configuration, wherein the first CSI configuration is associated with reception of common messages of rate splitting-based (RS-based) transmission, and wherein the second CSI configuration is associated with reception of WTRU-specific messages of RS-based transmission; and
receive, via the transceiver, at least one CSI report, the at least one CSI report comprising at least first CSI feedback and at least second CSI feedback, wherein the at least first CSI feedback is determined based on the first CSI configuration associated with the common messages of RS-based transmission, and wherein the at least second CSI feedback is determined based on the second CSI configuration associated with the WTRU-specific messages of RS-based transmission.

22. A method performed by a base station, the method comprising:
sending configuration information, wherein the configuration information comprises a first channel state information (CSI) configuration and a second CSI configuration, wherein the first CSI configuration is associated with reception of common messages of rate splitting-based (RS-based) transmission, and wherein the second CSI configuration is associated with reception of WTRU-specific messages of RS-based transmission; and
receiving at least one CSI report, the at least one CSI report comprising at least first CSI feedback and at least second CSI feedback, wherein the at least first CSI feedback is determined based on the first CSI configuration associated with the common messages of RS-based transmission, and wherein the at least second CSI feedback is determined based on the second CSI configuration associated with the WTRU-specific messages of RS-based transmission.
